(19) United States
(12) Patent Application Publication
(10) Pub. No.: US 2025/0140230 A1
(43) Pub. Date: May 1, 2025

(54) SOUND FIELD CONTROL SYSTEM AND SOUND FIELD CONTROL METHOD

(71) Applicant: ALPS ALPINE CO., LTD., Tokyo (JP)

(72) Inventor: Tomohiko ISE, Fukushima (JP)

(21) Appl. No.: 18/920,024

(22) Filed: Oct. 18, 2024

(30) Foreign Application Priority Data
Oct. 26, 2023 (JP) 2023-184097

(51) Int. Cl. G10K 11/175; H04R 3/04; H04R 3/12

(52) U.S. Cl. CPC G10K 11/1754; H04R 3/04; H04R 3/12

(57) ABSTRACT

A sound field control system hindering another person from hearing a listening target sound by a masker, includes speakers, a first sound field control part to output the listening target sound from the speakers, and a second sound field control part to output the masker from the speakers, wherein the first sound field control part applies the listening target sound to the speakers such that the listening target sound is locally reproduced in a closed space including the speakers and a listening zone within which the user listens to the listening target sound, and wherein the second sound field control part applies the masker to the speakers such that a sound pressure and a sound pressure gradient of the masker approach zero as closely as possible on a plane set to block a main propagation path of a direct sound from the speakers to the listening zone.

The present application is based on and claims priority to Japanese patent application No. 2023-184097 filed on Oct. 26, 2023, with the Japanese Patent Office, the entire contents of which are hereby incorporated by reference.

### BACKGROUND OF THE INVENTION

### 1. Field of the Invention

The disclosures herein relate to a technology to control a sound field so that the listening target sound, which is the sound that a user is listening to, is audible only to the user.

### 2. Description of the Related Art

As a technology to control the sound field so that the listening target sound, which is the sound that a user is listening to, is audible only to the user, there is known a technology of local sound reproduction that minimizes magnitude of the listening target sound propagating outside a first zone by outputting the listening target sound from a speaker so that a sound pressure and a sound pressure gradient of the listening target sound become zero at a boundary of the first zone where the user resides, using a technology of boundary sound field control based on a Kirchhoff-Helmholtz integral equation (e. g., Patent Literature (PTL) 1, 2).

Further, as the technology to control the sound field so that the listening target sound, which is the sound that the user is listening to, is audible only to the user, there is known a masking technology in which the speaker outputs the listening target sound to the first zone where the user is present, and a masker, which is a sound that inhibits listening of the listening target sound, is output from the speaker to a second zone, which is a zone where it is desired to prevent a listening target sound from being overheard, such as a zone where another person is present (e.g., PTL 3, 4).

Realistically, the technology of local sound reproduction applying the boundary sound field control described above cannot eliminate all the listening target sound propagated outside the first zone, and it is difficult to completely eliminate leakage of the listening target sound outside the first zone. For this reason, when the listening target sound is a human voice, which a human can recognize with high sensitivity, a content of the listening target sound may be recognized by other people that are outside the first zone. Additionally, according to the technology to prevent listening of the listening target sound in the second zone by outputting the masker to the second zone where listening of the listening target sound is desired to be suppressed, when the first zone and the second zone are relatively close spaces that are not isolated from each other, the masker may hinder the user in the first zone from listening to the listening target sound well.

An object of the present invention is to control the sound field so that the listening target sound, which is the sound to be listened to, is audible to the user without difficulty, and so that it is sufficiently difficult for others to listen to the sound.

### CITATION LIST

### Patent Literature

[PTL 1] Japanese Laid-Open Patent Publication No. 2006-74442

[PTL 2] Japanese Laid-Open Patent Publication No. 2008-252625

[PTL 3] Japanese Patent No. 6851980

[PTL 4] Japanese Patent No. 5761259

### SUMMARY OF THE INVENTION

In order to solve the problem, in the present invention, a sound field control system for hindering another person from hearing a listening target sound, which is intended for a user to hear, by using a masker which masks the listening target sound, the sound field control system includes a plurality of speakers, a first sound field control part configured to output the listening target sound from the plurality of speakers, and a second sound field control part configured to output the masker from the plurality of speakers, wherein the first sound field control part is configured to apply the listening target sound to the plurality of speakers such the listening target that sound is locally reproduced in a closed space including the plurality of speakers and a listening zone within which the user listens to the listening target sound, and wherein the second sound field control part is configured to apply the masker to the plurality of speakers such that a sound pressure and a sound pressure gradient of the masker approach zero as closely as possible on a plane set to block a main propagation path of a direct sound from the plurality of speakers to the listening zone.

Further, in order to solve the problem, in the present invention, the sound field control system for hindering another person from hearing a listening target sound, which is intended for a user to hear, by using a masker which masks the listening target sound, the sound field control system includes a plurality of sets, each of the sets including a speaker, a first filter configured to receive the listening target sound as an input and to output the listening target sound with a set transfer characteristic, a second filter configured to receive the masker as an input and to output the masker with a set transfer characteristic, and a mixer configured to mix an output of the first filter and an output of the second filter for output to the speaker, wherein the transfer characteristic of the first filter of each of the sets is configured such that a sound pressure and a sound pressure gradient of the listening target sound approach zero as closely as possible at a boundary of a closed space including a listening zone, within which the user listens to the listening target sound, and the speakers of the plurality of sets, and the transfer characteristic of the second filter of each of the sets is configured such that a sound pressure and a sound pressure gradient of the masker approach zero as closely as possible at a boundary of a space including the speakers of the plurality of sets yet not including the listening zone, the boundary of the space being located toward the listening zone.

Here, in the sound field control system, each of the sets of speakers may be arranged in front of the listening zone, wherein the front is direction in which the user listening to the listening target sound faces, the space, including the speakers of the plurality of sets yet not including the listening zone, may be set in front of the listening zone, and the transfer characteristic of the second filter of each of the sets may be configured such that the sound pressure and the sound pressure gradient of the masker approach zero as closely as possible at a rear boundary of the space, the rear boundary being situated toward the listening zone, and the masker is propagated toward outside the space through at least one of a front boundary or a lateral boundary of the space.

The sound field control system may include a plurality of acoustic sensors, and a transfer characteristic setting part configured to calculate and set the transfer characteristic of the first filter and the transfer characteristic of the second filter in each of the sets, such that responses at respective control points to the listening target sound and the masker become target responses based on outputs of the acoustic sensors, in a state where the plurality of acoustic sensors are arranged at the control points, the control points being set at least on the boundary of the closed space and on the boundary of the space situated toward the listening zone.

The sound field control system may further include a masker generating part configured to generate the masker, and adjust the generated masker in accordance with the listening target sound such that the generated masker is suitable for hindering hearing of the listening target sound. Moreover, the present disclosure provides a sound field control method for hindering another person from hearing a listening target sound, which is intended for a user to hear, by using a masker which masks the listening target sound, wherein the listening target sound and the masker are output from a plurality of speakers, a boundary sound field control of the listening target sound is performed so that a sound pressure and a sound pressure gradient of the listening target sound approach zero as closely as possible at a boundary of a closed space including a listening zone within which the user listens to the listening target sound, and the plurality of speakers, and a boundary sound field control of the masker is performed so that a sound pressure and a sound pressure gradient of the masker approach zero as closely as possible at a boundary of a space, including the plurality of sets of speakers yet not including the listening zone, the boundary of the space being located toward the listening zone.

According to the boundary sound field control system and the boundary sound field control method, since the masker does not propagate to the listening zone where the user listens to the listening target sound in the closed space where the listening target sound is locally reproduced, the user can satisfactorily listen to the listening target sound without being disturbed by the masker. In addition, since a zone which is not on the listening zone side as seen from the speaker outside the closed space can be set as a zone where the listening target sound does not leak out and the masker propagates, it is possible to sufficiently hinder the user to listen to the listening target sound in the other zone. In addition, by using the same speaker for the output of the listening target sound and the masker, it is possible to achieve the above-described improvement in listening to the listening target sound by the user and difficulty in listening to the listening target sound by others.

As described above, according to the present invention, it is possible to control the sound field so that the listening target sound, which is the sound to be listened to, is audible to the user without difficulty, and so that it is sufficiently difficult for others to listen.

### BRIEF DESCRIPTION OF THE DRAWINGS

FIG. 1 is a block diagram illustrating a configuration of a sound field control system according to the embodiment of the present invention;

FIG. 2A is a side view illustrating an example of a boundary to control sound pressure and a sound pressure gradient for a listening target sound in the sound field control system according to the embodiment of the present invention;

FIG. 2B is a top view illustrating an example of the boundary to the control sound pressure and the sound pressure gradient for the listening target sound in the sound field control system according to the embodiment of the present invention;

FIG. 2C is a side view illustrating an example of a boundary to control sound pressure and a sound pressure gradient for a masker in the sound field control system according to the embodiment of the present invention;

FIG. 2D is a top view illustrating an example of the boundary to control the sound pressure and the sound pressure gradient for the masker in the sound field control system according to the embodiment of the present invention;

FIG. 3A is a side view illustrating an example of sound field control by the sound field control system according to the embodiment of the present invention;

FIG. 3B is a top view illustrating an example of the sound field control by the sound field control system according to the embodiment of the present invention;

FIG. 4 is a drawing illustrating another example of sound field control by the sound field control system according to the embodiment of the present invention; and

FIG. 5 is a block diagram illustrating another example of a configuration of the sound field control system according to the embodiment of the present invention.

### DESCRIPTION OF THE PREFERRED EMBODIMENTS

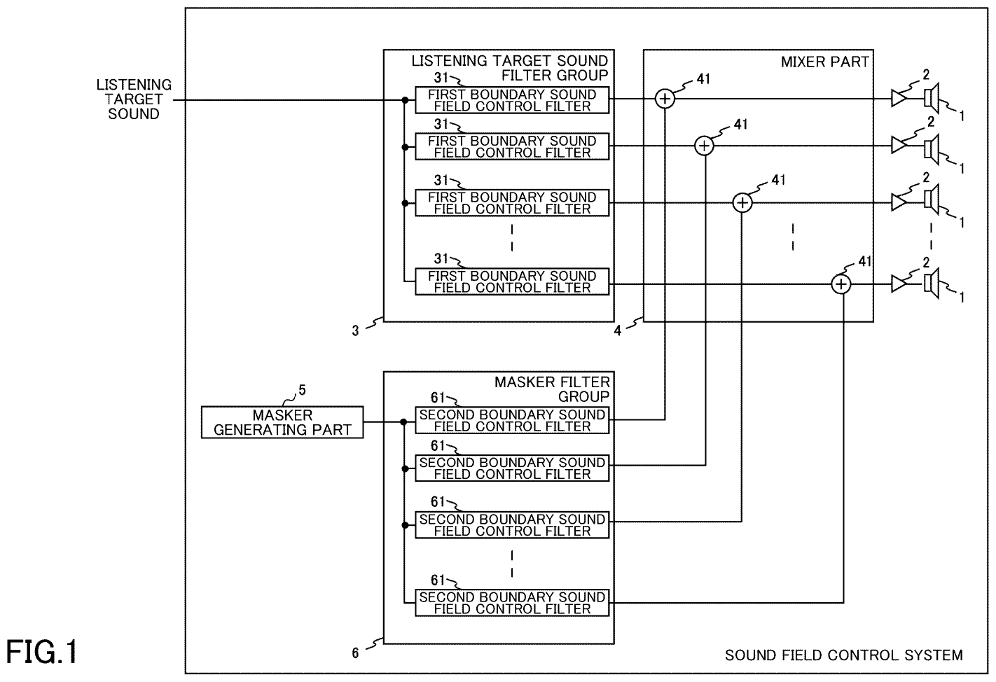

In the following, embodiments of the present invention will be described. FIG. 1 shows a configuration of a sound field control system according to the present embodiment. The present sound field control system is a system to control a sound field so that a listening target sound, which is a predetermined sound, is satisfactorily audible only to a user, and difficult for others to hear. As shown in the figure, the sound field control system includes a plurality of speakers 1, amplifiers 2 corresponding to each speaker 1, a listening target sound filter group 3, a mixer part 4, a masker generating part 5, and a masker filter group 6. The masker generating part 5 generates a predetermined masker such as a noise sound and outputs it to the masker filter group 6. The listening target sound filter group 3 includes a plurality of first boundary sound field control filters 31 corresponding to the plurality of speakers one-to-one, and each first boundary sound field control filter 31 receives the listening target sound. The masker filter group 6 includes a plurality of second boundary sound field control filters 61 corresponding to the plurality of speakers one-to-one, and each second boundary sound field control filter 61 receives a masker generated by the masker generating part 5. The mixer part 4 includes mixers 41 corresponding to the plurality of speakers one-to-one, and each mixer 41 mixes the output of the first boundary sound field control filter 31 corresponding to the same speaker 1, and the output of the second boundary sound field control filter 61 corresponding to the same speaker 1, and outputs it to the corresponding speaker 1 via the amplifier 2.

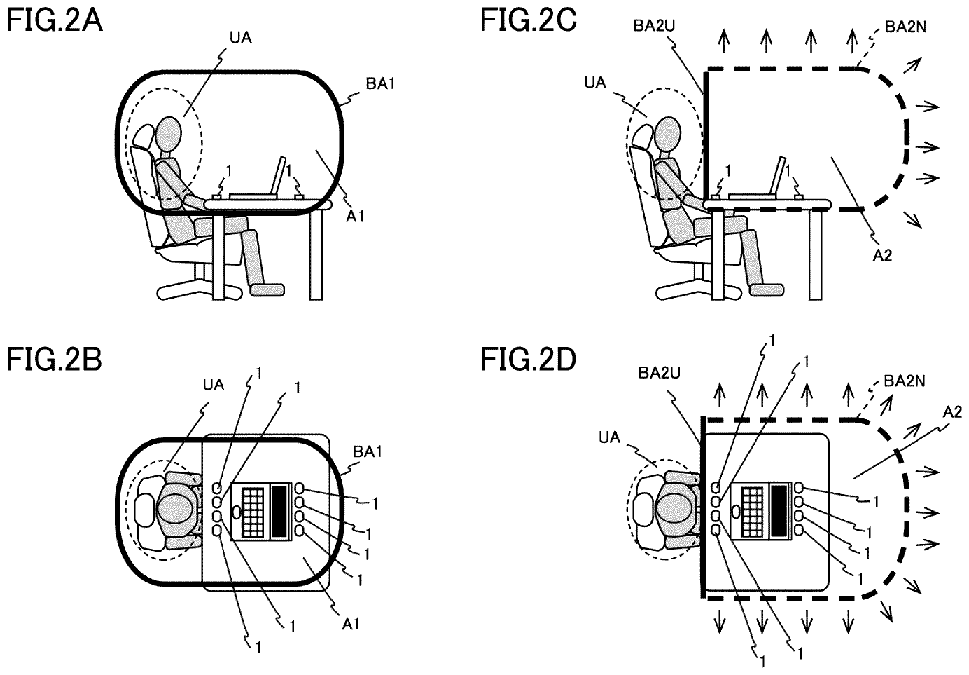

In such a configuration, each first boundary sound field control filter 31 is, for example, an FIR filter, and filter coefficients (transfer characteristics) to perform predetermined boundary sound field control for the listening target sound are set in advance. Each second boundary sound field control filter 61 is, for example, an FIR filter, and filter coefficients (transfer characteristics) to perform predetermined boundary sound field control for the masker are set in advance. FIGS. 2A to 2D show an example of boundary sound field control for the listening target sound achieved by each first boundary sound field control filter 31 of the listening target sound filter group 3, and an example of boundary sound field control for the masker achieved by each second boundary sound field control filter 61 of the masker filter group 6. The example of FIGS. 2A to 2D show a case where each part of the sound field control system except the speaker 1 is implemented by software of a PC (personal computer). Further, the present example shows a case where the user sitting in a chair in front of a desk performs a remote conference through the PC placed on the desk, and speech of another participant in the remote conference received by the PC is a listening target sound heard by the user. In the present example, the plurality of speakers 1 are arranged in front of and behind the PC. As seen in the lateral direction in FIG. 2A and seen from the top in FIG. 2B, the boundary sound field control for the listening target sound achieved by each first boundary sound field control filter 31 is a boundary sound field control which sets the sound pressure and the sound pressure gradient to approach zero as closely as possible at the boundary BA1, which is the boundary of a zone A1, which is a closed space including a zone UA, within which a head of the user is assumed to move during the remote conference, and each of the speakers 1, and by performing such boundary sound field control, the listening target sound leaked outside the boundary BA1 is minimized, and the listening target sound is locally reproduced within the zone A1. Note that, setting the sound pressure gradient at zero is equivalent to setting a particle velocity at zero.

Next, as seen in the lateral direction shown in FIG. 2C, and as seen from the top shown in FIG. 2D, the boundary sound field control for the masker achieved by each second boundary sound field control filter 61 is performed on the boundary of the zone A2 including each speaker 1, and without including the zone UA, within which the head of the user is assumed to move.

That is, the boundary sound field control is performed so that the sound pressure and the sound pressure gradient approach zero as closely as possible at the boundary BA2U, being located toward the zone UA and shown by a solid line, which blocks the main propagation path of the direct sound from each speaker 1 to the zone UA, and the masker is naturally radiated outside the zone A2 through the boundary BA2N, not being located toward the zone UA and shown by a broken line.

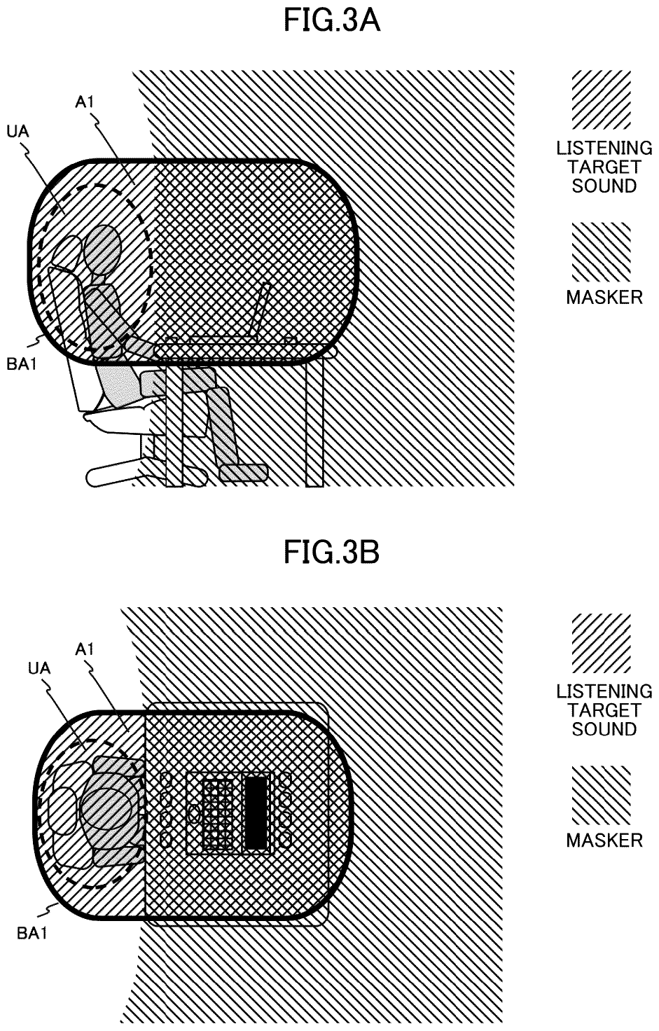

By performing such boundary sound field control, the masker that reaches the head of the user located within the zone UA from the boundary BA2U is minimized, and the masker reaches the direction that is not located toward the zone UA without greatly changing from the case where the boundary sound field control of the masker is not performed. By performing such boundary sound field control of the listening target sound and boundary sound field control of the masker, only the listening target sound is transmitted from the speaker 1 to the zone UA, within which the head of the user is assumed to move during the remote conference, in the zone A1, and almost no masker reaches the zone UA, as shown in FIG. 3A in the lateral direction and FIG. 3B from the top.

Therefore, during the remote conference, the user can listen to the listening target sound without being disturbed by the masker. Conversely, the masker is transmitted in the direction that is not located toward the zone UA as seen from each speaker 1, and the transmission of the listening target sound to an outside of the zone A1 is minimized. Therefore, the listening target sound hardly leaks out to the other person in the direction that is not located toward the zone UA as seen from the speaker 1 outside the zone A1, listening target sound leakage is also masked by the masker, and the listening target sound is inhibited. Also, since the listening target sound is hardly transmitted outside the zone A1 in the direction that is located toward the zone UA as seen from each speaker 1 outside the zone A1, it is possible to hinder the other person in the direction from listening to the listening target sound. When another person enters the zone where both the listening target sound and the masker are transmitted, located closer to each speaker 1 that is the zone UA in the zone A1, the masking of the listening target sound by the masker hinders hearing of the listening target sound. An example of the boundary sound field control performed by the sound field control system of the present embodiment has been described above. Here, in the examples shown in FIGS. 2A to 3B above, the case where each part of the sound field control system except the speaker 1 is implemented by software of the PC has been described, but a built-in speaker of the PC may be used as the speaker 1 of the sound field control system, or the sound field control system may be provided separately from the PC and the PC may be used as a sound source device for the listening target sound.

Further, in the above example, the speech spoken by another participant in the remote conference is set as the listening target sound, but any sound may be set as the listening target sound. That is, for example, any sound such as speech broadcasted by a radio broadcast or television broadcast, reproduced speech by an audio apparatus, or speech received by a telephone may be set as the listening target sound. Further, a number and arrangement of the speakers 1 and the boundaries BA1, BA2U, and BA2N in the examples shown in FIGS. 2A to 3B may be freely determined as long as the zone UA, within which the head of the user is assumed to move, is located within the closed space surrounded by the boundary BA1, and the boundary BA2U blocks the main propagation path of the direct sound from the speaker 1 to the zone UA.

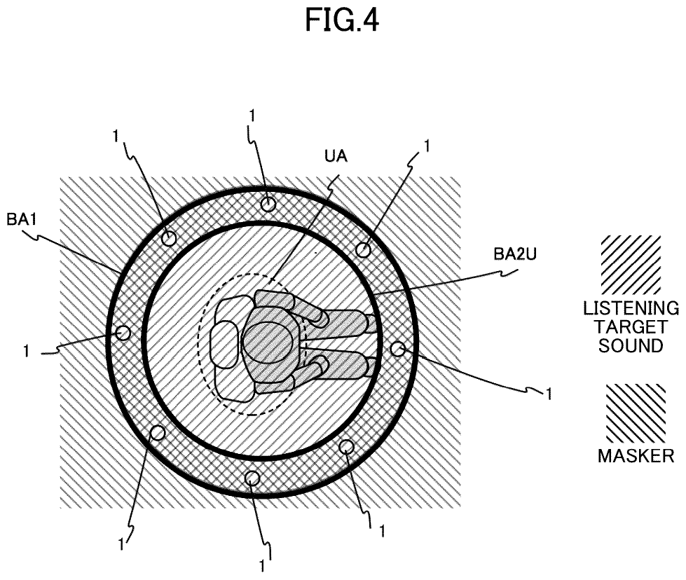

For example, as shown in FIG. 4, the plurality of speakers 1 may be arranged so as to surround the user, and the boundary BA1 in which the sound pressure and the sound pressure gradient of the listening target sound are set to approach zero as closely as possible, and the boundary BA2U in which the sound pressure and the sound pressure gradient of the masker are set to approach zero as closely as possible, may be set as boundaries with closed boundary surfaces so that each speaker 1 and the zone UA are included inside the boundary BA1, the boundary BA2U is included inside the boundary BA1 and each speaker 1, and the zone UA is included inside the boundary BA2U. Even if the boundaries BA1 and the boundary BA2U are set in this way, since only the listening target sound is propagated to the zone UA, the user can listen to the listening target sound satisfactorily. Also, since only the masker is propagated outside the boundary BA1, it is possible to sufficiently hinder others outside the boundary BA1 to listen to the listening target sound.

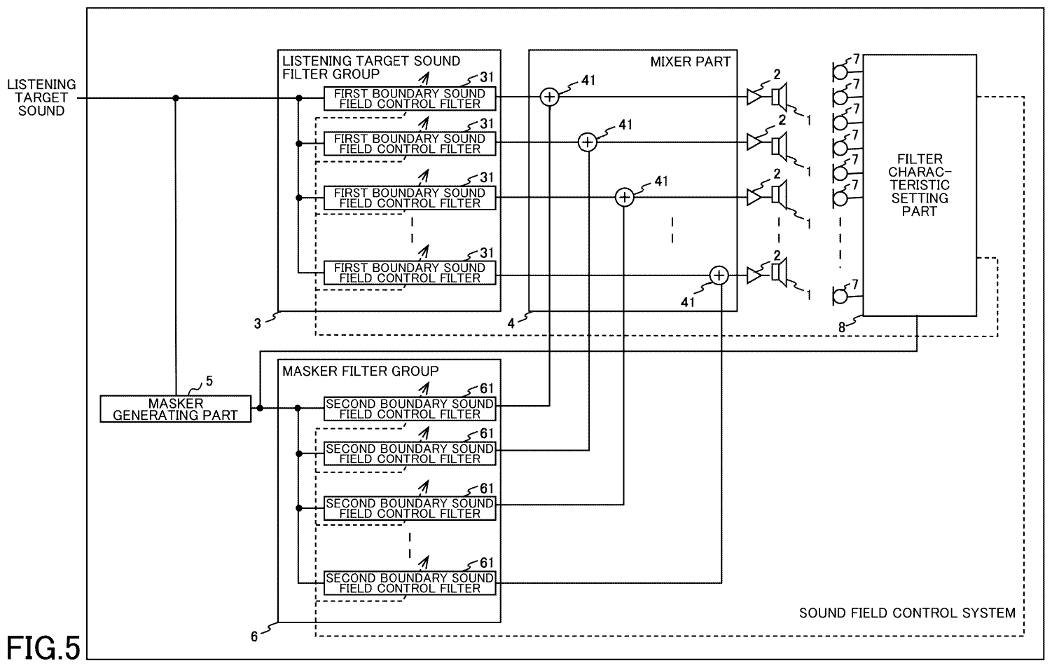

Further, in the sound field control system shown in FIG. 1, the masker generating part 5 may generate, as a masker, sound that is suitable for hindering hearing of the listening target sound according to the listening target sound. In this case, as shown in FIG. 5, the listening target sound is also input to the masker generating part 5, and the masker generating part 5 adjusts a level of the masker to be generated so that a ratio of the level to the listening target sound becomes constant, the masker generating part 5 generates a sound having a frequency band overlapping with the listening target sound as a masker, and the masker generating part 5 generates a sound having a frequency spectrum close to the listening target sound as a masker.

In addition, the sound field control system shown in FIG. 1 may include a function for setting filter coefficients (transfer characteristics) of the first boundary sound field control filter 31 of the listening target sound filter group 3 and the second boundary sound field control filter 61 of the masker filter group 6. In this case, for example, as shown in FIG. 5, the sound field control system includes a plurality of acoustic sensors 7 such as microphones, microphone arrays, sound pressure sensors and sound pressure gradient sensors, and a filter characteristic setting part 8. When an operation of the sound field control system is started, the sound field control system and other devices used together with the sound field control system are set, and each acoustic sensor 7 is arranged at each control point with a position on the boundary BA1 that is the boundary of the zone A1, a position on the boundary BA2U on the zone UA side of the zone A2, a position in the zone UA, and a position on the opposite side of the zone UA as seen from the boundary BA2U shown in FIGS. 2A to 2D as control points, and the filter characteristic setting part 8 performs an adjustment operation in response to the user's instruction.

In the adjustment operation, the filter characteristic setting part 8 obtains a transfer function from each speaker 1 to each control point based on a signal output to each speaker 1 and an output from each acoustic sensor 7, and calculates, from the obtained transfer function, a filter coefficient of the first boundary sound field control filter 31 and a filter coefficient of the second boundary sound field control filter 61 that achieve the target responses of the listening target sound and the masker at each control point, and sets them in the first boundary sound field control filter 31 and the second boundary sound field control filter 61.

Here, in the adjustment operation, while outputting a predetermined test signal from the masker generating part 5, the test signal may be controlled by the listening target sound filter group 3 and the masker filter group 6 and sequentially output to each speaker 1 as it is, and the filter characteristic setting part 8 may obtain a transfer function from each speaker 1 to each control point using the test signal as a signal output to each speaker 1.

In the case of the example shown in FIGS. 2A to 2D, it is not necessary to strictly control the response of the masker on the boundary BA2N, which is not located toward the zone UA of the zone A2, so that the acoustic sensor 7 may not be arranged with the position on the boundary BA2N as a control point. For example, a position in the center of the zone A2 or a position on the boundary BA1 opposite to the zone UA may be set as a position opposite to the zone UA when viewed from the boundary BA2U, and the target of the masker at this control point may be set as a response with sufficient sound pressure.

After the adjustment operation is completed, the acoustic sensor 7 is removed and the sound field control system is used. The embodiment of the present invention has been described above. As described above, according to the present embodiment, while the listening target sound is satisfactorily audible without being disturbed by the masker in the zone including the listening position of the user, the other approximate zones can be regarded as zones where the listening target sound does not leak out and the masker is transmitted, so that the listening of the listening target sound by other people in the other zones can be sufficiently hindered. The same speaker 1 is used to output the listening target sound and the masker, so that hearing of the listening target sound by others can be sufficiently hindered while the listening target sound is satisfactorily audible to the user.

What is claimed is:

1. A sound field control system for hindering another person from hearing a listening target sound, which is intended for a user to hear, by using a masker which masks the listening target sound, the sound field control system comprising:
a plurality of speakers;
a first sound field control part configured to output the listening target sound from the plurality of speakers; and
a second sound field control part configured to output the masker from the plurality of speakers,
wherein the first sound field control part is configured to apply the listening target sound to the plurality of speakers such that the listening target sound is locally reproduced in a closed space including the plurality of speakers and a listening zone within which the user listens to the listening target sound, and
wherein the second sound field control part is configured to apply the masker to the plurality of speakers such that a sound pressure and a sound pressure gradient of the masker approach zero as closely as possible on a plane set to block a main propagation path of a direct sound from the plurality of speakers to the listening zone.

2. A sound field control system for hindering another person from hearing a listening target sound, which is intended for a user to hear, by using a masker which masks the listening target sound, the sound field control system comprising:
a plurality of sets, each of the sets including:
a speaker;
a first filter configured to receive the listening target sound as an input and to output the listening target sound with a set transfer characteristic;
a second filter configured to receive the masker as an input and to output the masker with a set transfer characteristic; and
a mixer configured to mix an output of the first filter and an output of the second filter for output to the speaker, wherein
the transfer characteristic of the first filter of each of the sets is configured such that a sound pressure and a sound pressure gradient of the listening target sound approach zero as closely as possible at a boundary of a closed space including a listening zone, within which the user listens to the listening target sound, and the speakers of the plurality of sets, and
the transfer characteristic of the second filter of each of the sets is configured such that a sound pressure and a sound pressure gradient of the masker approach zero as closely as possible at a boundary of a space including the speakers of the plurality of sets yet not including the listening zone, the boundary of the space being located toward the listening zone.

3. The sound field control system according to claim 2, wherein:
each of the sets of speakers is arranged in front of the listening zone, wherein the front is a direction in which the user listening to the listening target sound faces;
the space, including the speakers of the plurality of sets yet not including the listening zone, is set in front of the listening zone; and
the transfer characteristic of the second filter of each of the sets is configured such that the sound pressure and the sound pressure gradient of the masker approach zero as closely as possible at a rear boundary of the space, the rear boundary being situated toward the listening zone, and the masker is propagated toward outside the space through at least one of a front boundary or a lateral boundary of the space.

4. The sound field control system according to claim 2, further comprising:
a plurality of acoustic sensors; and
transfer characteristic setting part configured to calculate and set the transfer characteristic of the first filter and the transfer characteristic of the second filter in each of the sets, such that responses at respective control points to the listening target sound and the masker become target responses based d on outputs of the acoustic sensors, in a state where the plurality of acoustic sensors are arranged at the control points, the control points being set at least on the boundary of the closed space and on the boundary of the space situated toward the listening zone.

5. The sound field control system according to claim 2, further comprising a masker generating part configured to generate the masker, and adjust the generated masker in accordance with the listening target sound such that the generated masker is suitable for hindering hearing of the listening target sound.

6. A sound field control method for hindering another person from hearing a listening target sound, which is intended for a user to hear, by using a masker which masks the listening target sound, wherein:
the listening target sound and the masker are output from a plurality of speakers;
a boundary sound field control of the listening target sound is performed so that a sound pressure and a sound pressure gradient of the listening target sound approach zero as closely as possible at a boundary of a closed space including a listening zone within which the user listens to the listening target sound, and the plurality of speakers; and
a boundary sound field control of the masker is performed so that a sound pressure and a sound pressure gradient of the masker approach zero as closely as possible at a boundary of a space, including the plurality of sets of speakers yet not including the listening zone, the boundary of the space being located toward the listening zone.
